(19) United States
(12) Patent Application Publication
(10) Pub. No.: US 2013/0017288 A1
(43) Pub. Date: Jan. 17, 2013

(54) Mold-Tool Assembly having Nozzle Assemblies to Provide Resins Molded Adjacently

(71) Applicant: Martin Baumann, Burlington, VT (US)

(72) Inventor: Martin Baumann, Burlington, VT (US)

(73) Assignee: Husky Injection Molding Systems Ltd., Bolton, ON (CA)

(21) Appl. No.: 13/637,686

(22) PCT Filed: Mar. 21, 2011
(86) PCT No.: PCT/US11/29128

§ 371 Date: Sep. 27, 2012

Related U.S. Application Data
(60) Provisional application No. 61/318,852, filed on Mar. 30, 2010.

(51) Int. Cl. B29C 45/13

(52) U.S. Cl. 425/130

(57) ABSTRACT

A mold-tool assembly (100), comprising: a first nozzle assembly (110) being configured to provide a first resin (112) to a first mold cavity (114); and a second nozzle assembly (116) being configured to provide a second resin (118) to a second mold cavity (120), the second resin (118) being provided adjacent to the first resin (112).

### TECHNICAL FIELD

An aspect of the present invention generally relates to (but is not limited to) a mold-tool assembly having nozzle assemblies configured to provide resins to mold cavities, the resins provided adjacently to each other.

### BACKGROUND

The first man-made plastic was invented in Britain in 1851 by Alexander PARKES. He publicly demonstrated it at the 1862 International Exhibition in London, calling the material Parkesine. Derived from cellulose, Parkesine could be heated, molded, and retain its shape when cooled. It was, however, expensive to produce, prone to cracking, and highly flammable. In 1868, American inventor John Wesley HYATT developed a plastic material he named Celluloid, improving on PARKES' invention so that it could be processed into finished form. HYATT patented the first injection molding machine in 1872. It worked like a large hypodermic needle, using a plunger to inject plastic through a heated cylinder into a mold. The industry expanded rapidly in the 1940s because World War II created a huge demand for inexpensive, mass-produced products. In 1946, American inventor James Watson HENDRY built the first screw injection machine. This machine also allowed material to be mixed before injection, so that colored or recycled plastic could be added to virgin material and mixed thoroughly before being injected. In the 1970s, HENDRY went on to develop the first gas-assisted injection molding process.

Injection molding machines consist of a material hopper, an injection ram or screw-type plunger, and a heating unit. They are also known as presses, they hold the molds in which the components are shaped. Presses are rated by tonnage, which expresses the amount of clamping force that the machine can exert. This force keeps the mold closed during the injection process. Tonnage can vary from less than five tons to 6000 tons, with the higher figures used in comparatively few manufacturing operations. The total clamp force needed is determined by the projected area of the part being molded. This projected area is multiplied by a clamp force of from two to eight tons for each square inch of the projected areas. As a rule of thumb, four or five tons per square inch can be used for most products. If the plastic material is very stiff, it will require more injection pressure to fill the mold, thus more clamp tonnage to hold the mold closed. The required force can also be determined by the material used and the size of the part, larger parts require higher clamping force. With Injection Molding, granular plastic is fed by gravity from a hopper into a heated barrel. As the granules are slowly moved forward by a screw-type plunger, the plastic is forced into a heated chamber, where it is melted. As the plunger advances, the melted plastic is forced through a nozzle that rests against the mold, allowing it to enter the mold cavity through a gate and runner system. The mold remains cold so the plastic solidifies almost as soon as the mold is filled. Mold assembly or die are terms used to describe the tooling used to produce plastic parts in molding. The mold assembly is used in mass production where thousands of parts are produced. Molds are typically constructed from hardened steel, etc. Hot-runner systems are used in molding systems, along with mold assemblies, for the manufacture of plastic articles. Usually, hot-runners systems and mold assemblies are treated as tools that may be sold and supplied separately from molding systems.

U.S. Pat. No. 4,521,179 discloses a moveable core ring gated injection molding system. Pressurized melt from a molding machine flows through the system and into a cavity. A gate leading to the cavity and a bore in the movable mold platen are in alignment and of the same size to receive the head portion of the valve pin which extends from a reduced neck portion. Actuating mechanism drives the valve pin between a retracted closed position to an open position in which the reduced neck portion extends into the cavity. In the closed position, the head portion of the valve pin extends a considerable distance into the bore in the mold platen to provide sufficient cooling to rapidly cool the melt in the cavity adjacent the pin. In one embodiment, the valve pin has a hollow portion adjacent the neck portion to provide the valve pin with thermal separation between the hot melt and the cool mold platen. In another embodiment, the valve pin has a copper portion between the hollow portion and the tip end to promote cooling of the melt in the cavity.

U.S. Pat. No. 5,071,335 discloses an injection molding tool for production of a magnetic tape cassette casing constructed, in part, in two layers. The apparatus has a fixed core provided, on the rim, with a projection which provides a sealing strip relative to the moving core. After the injection molding process into the first mould cavity, the moving core is moved axially downwards by about half the wall thickness, whereupon the second mould cavity is filled by injection through a second needle shut-off nozzle.

U.S. Pat. No. 5,084,223 discloses a mold for forming a magnetic tape cassette and a method for multi-color molding a magnetic tape cassette or the like. Sprue-runners connected to submarine gates used in making at least portions of the cassette are formed with notches near the submarine gates to reduce the cross-sectional area of the sprue-runners. As result, the sprue-runners can be easily cut off from the body of the cassette by breaking the notched portions.

U.S. Pat. No. 6,074,593 discloses an arrangement and method for mounting a core pin for an injection molding a part, includes mounting a core pin in a cavity plate to extend upwardly through the cavity and into an opening in one end of a valve sleeve operated to control melt injection through a gate in a heated injection nozzle. The core pin moves away from the injection nozzle when the cavity plate is separated to remove the part.

U.S. Pat. No. 6,328,920 discloses a plastic part having a complex structure as a first layer and a simple structure as a second layer, is formed using a method for molding. Initially, a single mold is provided, the mold having an interior cavity and a runner reaching from an exterior of the mold to the cavity. The mold is kept closed while a quantity of a first plastic material is injected via the runner into the interior cavity to form a first layer of the plastic part. The mold is then partially opened, creating an increased interior cavity section, into which a quantity of a second plastic material is injected, via the runner, to form a second layer of the plastic part. The solidified plastic part can then be ejected from the mold.

U.S. Patent Publication No. 20050266254 discloses a plastic injection molded part having a molded metal reinforcement located therein.

### SUMMARY

According to one aspect, there is provided a mold-tool assembly (100), comprising: a first nozzle assembly (110) being configured to provide a first resin (112) to a first mold cavity (114); and a second nozzle assembly (116) being configured to provide a second resin (118) to a second mold cavity (120), the second resin (118) being provided adjacent to the first resin (112).

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

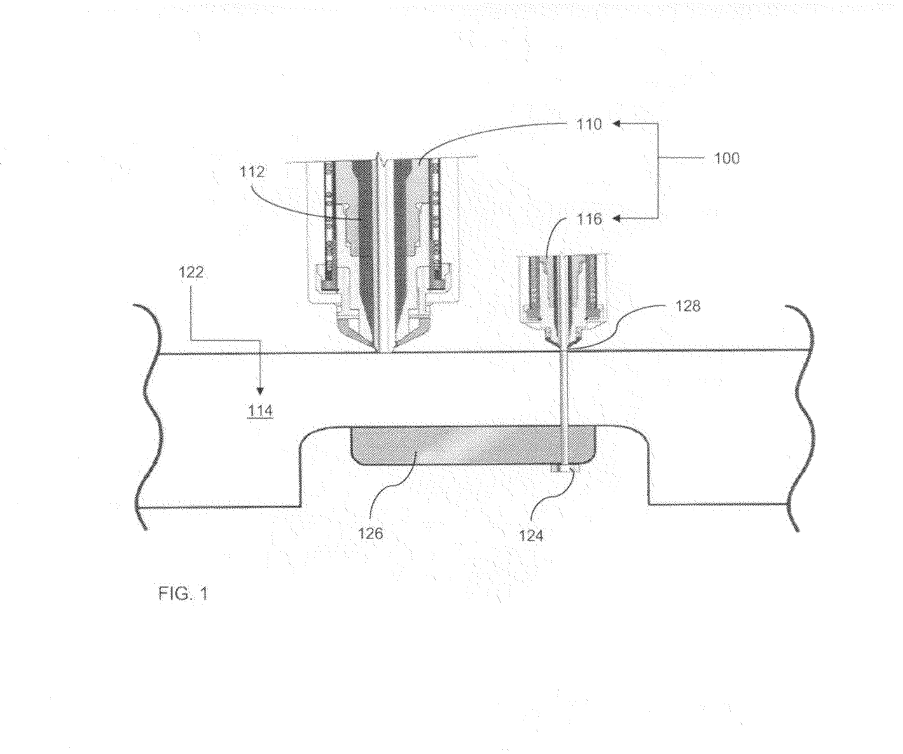

FIGS. 1-3 depict schematic representations of a mold-tool assembly (100).

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

FIGS. 1-3 depict schematic representations of a mold-tool assembly (100). The mold-tool assembly (100) may include components that are known to persons skilled in the art, and these known components will not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems”3^{rd} Edition authored by JOHANNABER (ISBN 3-446-17733-7) and/or (iv) “Runner and Gating Design Handbook” authored by BEAUMONT (ISBN 1-446-22672-9). It will be appreciated that for the purposes of this document, the phrase “includes (but is not limited to)” is equivalent to the word “comprising”. The word “comprising” is a transitional phrase or word that links the preamble of a patent claim to the specific elements set forth in the claim which define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

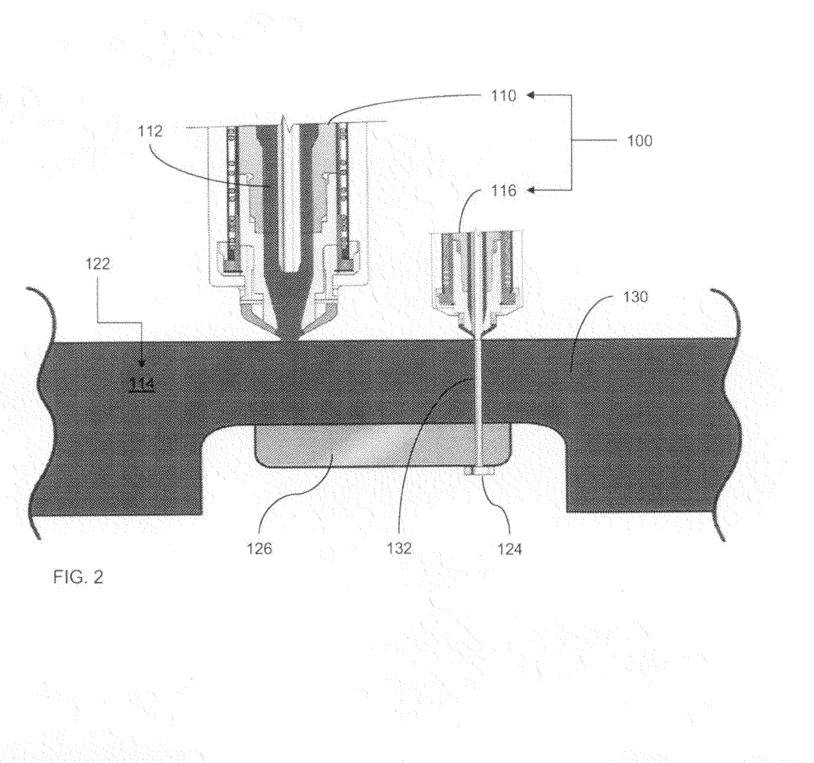

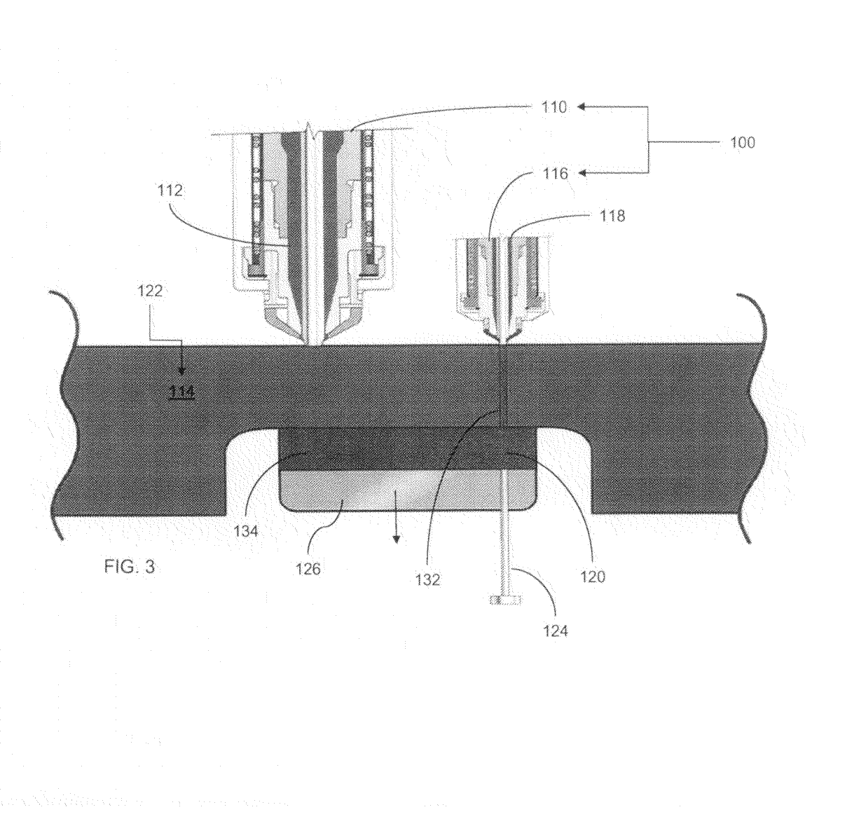

FIG. 1 depicts the mold-tool assembly (100) in the case before the manufacture of any molded articles. The mold-tool assembly (100) includes (but is not limited to): (i) a first nozzle assembly (110), (ii) a second nozzle assembly (116). The first nozzle assembly (110) is configured, as depicted in FIG. 2, to provide a first resin (112) to a first mold cavity (114). FIGS. 1 and 3 depict the first nozzle assembly (110) in a no-flow state (that is, no resin flows), and FIG. 2 depicts the first nozzle assembly (110) in a flow state (that is, resin flows). The second nozzle assembly (116) is configured, as depicted in FIG. 3, to provide a second resin (118) to a second mold cavity (120), and the second resin (118) will be provided adjacent to the first resin (112). FIGS. 1 and 2 depict the second nozzle assembly (116) in a no-flow state (that is, no resin flows), and FIG. 3 depicts the second nozzle assembly (116) in a flow state (that is, resin flows).

The mold-tool assembly (100) further includes (but is not limited to): (i) a mold assembly (122), (ii) a mold pin (124), and (iii) a mold core (126). The mold assembly (122) has (or defines) the first mold cavity (114) that is in fluid communication with the first nozzle assembly (110), so that the first resin (112) may flow from the first nozzle assembly (110) into the first mold cavity (114) when actuated to do so. By way of example, and not limited thereto, the mold assembly (122) includes a stationary-mold portion and a movable-mold portion that is movable (and separable) relative to the stationary mold portion. The mold assembly (122) is supported in platen structure of a molding system (not depicted but known). The mold pin (124) is in communication with the second nozzle assembly (116) through the first mold cavity (114). That is, the mold pin (124) extends and is movable through the first mold cavity (114) when actuated to do so. The mold core (126) is movable (when actuated to do so) within the first mold cavity (114) between a first position and a second position. The first position is depicted in FIGS. 1 and 2, and the second position is depicted in FIG. 3.

In the first position, as depicted in FIG. 1, the mold core (126) defines, at least in part, the first mold cavity (114). More specifically, the mold pin (124) extends through the first mold cavity (114) so as to be in contact with an exit (128) of the second nozzle assembly (116).

In the first position, as depicted in FIG. 2, the first nozzle assembly (110) operates in the flow condition so as to provide the first resin (112) to the first mold cavity (114), and the first mold cavity (114) may form a first molded article (130). In addition, the mold pin (124) extends through the first molded article (130) so as to form a passageway (132) through the first molded article (130) toward the second nozzle assembly (116).

In the second position, as depicted in FIG. 3, the mold core (126) is offset (that is, moved or retracted) from the first molded article (130) formed in the first mold cavity (114) so that the second mold cavity (120) is formed between the first molded article (130) and the mold core (126). In addition, the mold pin (124) is moved away from the second nozzle assembly (116), and the mold pin (124) leaves behind the passageway (132) in the first molded article (130) formed in the first mold cavity (114), and the passageway (132) leads from the second nozzle assembly (116) to the second mold cavity (120). In addition, the second nozzle assembly (116) operates in the flow condition to provide the second resin (118) to flow through the passageway (132) past the first molded article (130) to the second mold cavity (120) so as to form a second molded article (134) in the second mold cavity (120). Once the second mold cavity (120) is filled then the second resin (118) stops flowing from the second nozzle assembly (116). The first resin (112) and the second resin (118) solidify, and then the first molded article (130) and the second molded article (134) may then be removed from the first mold cavity (114) and the second mold cavity (120).

It is understood that the scope of the present invention is limited to the scope provided by the independent claims, and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (but is not limited to)” is equivalent to the word “comprising”. The word “comprising” is a transitional phrase or word that links the preamble of a patent claim to the specific elements set forth in the claim which define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim. It is noted that the foregoing has outlined the non-limiting embodiments. Thus, although the description is made for particular non-limiting embodiments, the scope of the present invention is suitable and applicable to other arrangements and applications. Modifications to the non-limiting embodiments can be effected without departing from the scope of the independent claims. It is understood that the non-limiting embodiments are merely illustrative.

What is claimed is:

1. A mold-tool assembly (100), comprising:
a first nozzle assembly (110) being configured to provide a first resin (112) to a first mold cavity (114); and
a second nozzle assembly (116) being configured to provide a second resin (118) to a second mold cavity (120), the second resin (118) being provided adjacent to the first resin (112).

2. The mold-tool assembly (100) of claim 1, further comprising:
a mold assembly (122) having the first mold cavity (114) being in fluid communication with the first nozzle assembly (110);
a mold pin (124) being in communication with the second nozzle assembly (116) through the first mold cavity (114); and
a mold core (126) being movable within the first mold cavity (114) between a first position and a second position.

3. The mold-tool assembly (100) of claim 2, wherein in the first position,
the mold core (126) defines, at least in part, the first mold cavity (114), and
the mold pin (124) extends through the first mold cavity (114) so as to be in contact with an exit (128) of the second nozzle assembly (116).

4. The mold-tool assembly (100) of claim 3, wherein in the first position,
the first nozzle assembly (110) provides the first resin (112) to the first mold cavity (114), which forms a first molded article (130), and
the mold pin (124) extends through the first molded article (130) so as to form a passageway (132) through the first molded article (130).

5. The mold-tool assembly (100) of claim 4, wherein in the second position,
the mold core (126) is offset from the first molded article (130) formed in the first mold cavity (114) so that the second mold cavity (120) is formed between the first molded article (130) and the mold core (126).

6. The mold-tool assembly (100) of claim 5, wherein in the second position,
the mold pin (124) is moved away from the second nozzle assembly (116) and leaves behind the passageway (132) in the first molded article (130) formed in the first mold cavity (114), the passageway (132) leading from the second nozzle assembly (116) to the second mold cavity (120).

7. The mold-tool assembly (100) of claim 6, wherein in the second position,
the second nozzle assembly (116) provides the second resin (118) to flow through the passageway (132) past the first molded article (130) to the second mold cavity (120) so as to form a second molded article (134) in the second mold cavity (120).

8. A molding system having the mold-tool assembly (100) of any one of claims 1 to 7.
